(19) United States
(12) Patent Application Publication
(10) Pub. No.: US 2024/0110134 A1
(43) Pub. Date: Apr. 4, 2024

(54) PACKAGED ALCOHOL BEVERAGE INCLUDING STEVIOL GLYCOSIDE

(71) Applicant: SUNTORY HOLDINGS LIMITED, Osaka (JP)

(72) Inventors: Kunihito Takamiya, Clermont, KY (US); Genya Sugano, Clermont, KY (US); Dawn Marie Karels, Clermont, KY (US); Teresa Lynn Aldredge, Clermont, KY (US); Heather Marie Daines, Clermont, KY (US); Saki Kozu, Kawasaki-shi (JP); Shunya Fujita, Kawasaki-shi (JP); Ruri Uehara, Kawasaki-shi (JP)

(73) Assignee: SUNTORY HOLDINGS LIMITED, Osaka (JP)

(21) Appl. No.: 17/958,943

(22) Filed: Oct. 3, 2022

(51) Int. Cl. C12G 3/06

(52) U.S. Cl. CPC C12G 3/06

(57) ABSTRACT

The alcoholic beverage is contained in a container. The alcoholic beverage includes: an alcohol; a steviol glycoside selected from the group consisting of RebA; RebD and RebM, and at least one of sodium benzoate and potassium sorbate in a content of 0.001 g/100 ml to 0.15 g/100 ml. The alcoholic beverage has a pH of 2.0 to 3.6.

### THE FIELD OF THE INVENTION

The present invention relates to an alcoholic beverage including steviol glycoside having a natural aftertaste.

### RELATED ART

Conventionally, various kinds of alcoholic beverage have been developed. Recently, alcoholic beverages with various tastes or flavors with a wide range of alcohol content are sold as packaged alcoholic beverages worldwide in consideration of diversification of consumer tastes. Examples of such alcoholic beverages include spirits, cocktails and highballs, which include fruit juice or flavoring. Furthermore, products with reduced calories have become popular.

Related art reference No. 1 discloses an alcoholic beverage comprising at least one of steviol glycosides selected from the group consisting of rebaudioside D and rebaudioside M, in which the content of the steviol glycosides is 0.004 to 0.05 g/100 ml, and in which the alcohol content is 1.0 to 40.0 v/v %.

Document No. 1: JP Patent No. 7012919

### SUMMARY OF THE INVENTION

Steviol glycoside such as RebD (or rebaudioside D) can be used as a sweetener to make alcoholic beverage having a low calory. However, steviol glycoside such as RebA, RebD and RebM produces a negative taste such as a bitter taste, an astringency and a miscellaneous taste, thereby making conventional alcoholic beverages somewhat an artificial taste. The present application describes an alcoholic beverage which includes of RebA; RebD and/or RebM and has a natural taste. In particular, the present application provides an alcoholic beverage in which a negative taste from RebA, RebD and RebM is not felt, and to produce natural taste feelings.

In one embodiment, the inventive alcoholic beverage is contained in a container, the alcoholic beverage including: an alcohol; one or more kinds of steviol glycosides selected from the group consisting of RebA; RebD and RebM, and at least one of sodium benzoate and potassium sorbate in a content of 0.001 g/100 ml to 0.1 g/100 ml; in which the alcoholic beverage has a pH of 2.0 to 3.6.

In one embodiment, a content of the RebA; RebD and RebM, is 50 ppm to 500 ppm.

In one embodiment, the steviol glycoside is RebD.

In one embodiment, a content of the alcohol is 2 v/v % to 8 v/v %.

In one embodiment, the alcoholic beverage further includes a lemon juice. In addition, the content of the limon juice can be 0.1 w/v % to 20 w/v % in terms of a straight juice basis.

In one embodiment, the alcoholic beverage further includes a sugar.

In one embodiment, a content of the sugar is 0.3 to 3.0 g/100 ml.

In one embodiment, a Na content of the alcoholic beverage is 10.0 to 30.0 mg per 12 oz.

In one embodiment, the alcoholic beverage has a pH of 2.40 to 4.00.

In one embodiment, the alcoholic beverage is a carbonated beverage.

### BRIEF DESCRIPTION OF THE DRAWINGS

FIG. 1 shows the results of the evaluation regarding sourness (A-1) of the samples by means of a taste sensor device.

FIG. 2 shows the results of the evaluation regarding acidic bitterness (A-2) of the samples by means of a taste sensor device.

FIG. 3 shows the results of the evaluation regarding astringency (A-3) of the samples by means of a taste sensor device.

FIG. 4 shows the results of the evaluation regarding Umami (A-4) of the samples by means of a taste sensor device.

FIG. 5 shows the results of the evaluation regarding a ratio, (A-1)/(A-5)×100, of samples Nos. 14-22, by means of a taste sensor device.

### DETAILED DESCRIPTION OF THE INVENTION

1-1. Alcohol

As one embodiment, there is provided an alcoholic beverage. As an alcohol, liquor, spirits, etc. including shochu, whiskey, vodka, gin, brandy, rum, tequila, etc. can be used. In one embodiment, neutral spirit can be used.

In one embodiment, the alcoholic beverage has a content of the alcohol at 2 v/v % to 8 v/v %. In another embodiment, the content of the alcohol is 2 v/v % to 3 v/v %; 3 v/v % to 4 v/v %; 4 v/v % to 5 v/v %; 5 v/v % to 6 v/v %; 5 v/v % to 6 v/v %; 6 v/v % to 7 v/v %; and/or 7 v/v % to 8 v/v %.

In yet another embodiment, the alcoholic beverage has a content of the alcohol at 2.5 v/v % to 7.5 v/v %, 3.0 v/v % to 7.0 v/v %, 3.5 v/v % to 6.5 v/v %, 4.0 v/v % to 6.0 v/v %, 4.5 v/v % to 5.5 v/v %, 2.50 v/v % to 7.0 v/v %, 2.0 v/v % to 6.0 v/v %, 2.0 v/v % to 5.0 v/v %, 3.0 v/v % to 7.0 v/v %, 3.0 v/v % to 6.0 v/v %, or 3.0 v/v % to 5.0 v/v %.

In yet another embodiment, the alcoholic beverage has a content of the alcohol at 2.3 v/v % or more; 3.3 v/v % or more; 4.3 v/v % or more; or 5.3 v/v % or more. With or without the lower limit specified above, the alcoholic beverage has a content of the alcohol at 7.8 v/v % or lower; 6.8 v/v % or lower; 5.8 v/v % or lower; or 4.8 v/v % or lower.

1-2. Steviol Glycoside

The alcoholic beverage of the present application includes at least one of RebA, RebD and RebM. Leaves of Stevia rebaudiana contain a secondary metabolite, i.e., a kind of diterpenoid, called as steviol. A glycoside of steviol, i.e., steviol glycoside, is sweet, the sweetness of which is about 300 times as strong as that of sugar.

1-2-1. RebA, RebD and RebM

In particular, the alcoholic beverage can include RebA, RebD and/or RebM. In one embodiment, the alcoholic beverage can include RebD. In one embodiment, the content of RebA, RebD and/or RebM can be 50 ppm to 500 ppm.

In one embodiment, the alcoholic beverage includes RebA, RebD and/or RebM at 50 to 60 ppm; 60 to 70 ppm; 70 to 80 ppm; 80 to 90 ppm; 90 to 100 ppm; 100 to 110 ppm; 110 to 120 ppm; 120 to 130 ppm; 130 to 140 ppm; 140 to 150 ppm; 150 to 160 ppm; 160 to 170 ppm; 170 to 180 ppm; 180 to 190 ppm; 190 to 200 ppm; 200 to 210 ppm; 210 to 220 ppm; 220 to 230 ppm; 230 to 240 ppm; 240 to 250 ppm; 250 to 260 ppm; 260 to 270 ppm; 270 to 280 ppm; 280 to 290 ppm; 290 to 300 ppm; 300 to 310 ppm; 310 to 320 ppm; 320 to 330 ppm; 330 to 340 ppm; 340 to 350 ppm; 350 to 360 ppm; 360 to 370 ppm; 370 to 380 ppm; 380 to 390 ppm; 390 to 400 ppm; 400 to 410 ppm; 410 to 420 ppm; 420 to 430 ppm; 430 to 440 ppm; 440 to 450 ppm; 450 to 460 ppm; 460 to 470 ppm; 470 to 480 ppm; 480 to 490 ppm; and/or 490 to 500 ppm.

In yet another embodiment, the alcoholic beverage includes RebA, RebD and/or RebM at 50 to 480 ppm; 50 to 450 ppm; 50 to 430 ppm; 50 to 400 ppm; 50 to 370 ppm; 50 to 350 ppm; 50 to 320 ppm; 50 to 300 ppm; 50 to 280 ppm; 50 to 270 ppm; 50 to 250 ppm; 50 to 240 ppm; 50 to 230 ppm; 50 to 220 ppm; 50 to 200 ppm; 80 to 430 ppm; 80 to 400 ppm; 80 to 370 ppm; 80 to 350 ppm; 80 to 320 ppm; 80 to 300 ppm; 80 to 280 ppm; 80 to 270 ppm; 80 to 250 ppm; 80 to 240 ppm; 80 to 230 ppm; 80 to 220 ppm; 80 to 200 ppm; 100 to 430 ppm; 100 to 400 ppm; 100 to 370 ppm; 100 to 350 ppm; 100 to 430 ppm; 100 to 400 ppm; 100 to 370 ppm; 100 to 350 ppm; 100 to 320 ppm; 100 to 300 ppm; 100 to 280 ppm; 100 to 270 ppm; 100 to 250 ppm; 100 to 240 ppm; 100 to 230 ppm; 100 to 220 ppm; 100 to 200 ppm; 120 to 430 ppm; 120 to 400 ppm; 120 to 370 ppm; 120 to 350 ppm; 120 to 320 ppm; 120 to 300 ppm; 120 to 280 ppm; 120 to 270 ppm; 120 to 250 ppm; 120 to 240 ppm; 120 to 230 ppm; 120 to 220 ppm; 120 to 200 ppm; 140 to 430 ppm; 140 to 400 ppm; 140 to 370 ppm; 140 to 350 ppm; 140 to 320 ppm; 140 to 300 ppm; 140 to 280 ppm; 140 to 270 ppm; 140 to 250 ppm; 140 to 240 ppm; 140 to 230 ppm; 140 to 220 ppm; or 140 to 200 ppm.

In yet another embodiment, the content of the RebA, RebD and/or RebM can be 50 ppm or more; 60 ppm or more; 80 ppm or more; 90 ppm or more; 100 ppm or more; 110 ppm or more; 120 ppm or more; 140 ppm or more; 160 ppm or more; or 180 ppm or more. With or without the lower limit specified above, the content of the RebA, RebD and/or RebM can be 500 ppm or lower; 480 ppm or lower; 450 ppm or lower; 430 ppm or lower; 420 ppm or lower; 400 ppm or lower; 380 ppm or lower; 360 ppm or lower; 350 ppm or lower; 330 ppm or lower; 320 ppm or lower; 300 ppm or lower; 280 ppm or lower; 260 ppm or lower; 250 ppm or lower; 240 ppm or lower; 230 ppm or lower; 220 ppm or lower; or 200 ppm or lower.

1-3. Sodium Benzoate and Potassium Sorbate

The alcoholic beverage includes at least one of sodium benzoate and potassium sorbate. In one embodiment, the alcoholic beverage includes sodium benzoate alone. In one embodiment, the alcoholic beverage includes potassium sorbate alone. In yet another embodiment, the alcoholic beverage includes both of sodium benzoate and potassium sorbate.

The content of the at least one of sodium benzoate and potassium sorbate in the alcoholic beverage can be 0.001 g/100 ml to 0.1 g/100 ml.

In one embodiment, the alcoholic beverage includes sodium benzoate at a content of 0.005 g/100 ml to 0.05 g/100 ml. In another embodiment, the alcoholic beverage includes sodium benzoate at a content of 0.005 g/100 ml to 0.01 g/100 ml; 0.01 g/100 ml to 0.02 g/100 ml; 0.02 g/100 ml to 0.03 g/100 ml; 0.03 g/100 ml to 0.04 g/100 ml; 0.04 g/100 ml to 0.05 g/100 ml; 0.05 g/100 ml to 0.06 g/100 ml; 0.06 g/100 ml to 0.07 g/100 ml; 0.07 g/100 ml to 0.08 g/100 ml; 0.08 g/100 ml to 0.09 g/100 ml; 0.09 g/100 ml to 0.1 g/100 ml.

In yet another embodiment, the alcoholic beverage includes sodium benzoate at a content of 0.005 g/100 ml to 0.1 g/100 ml; 0.005 g/100 ml to 0.08 g/100 ml; 0.005 g/100 ml to 0.05 g/100 ml; 0.01 g/100 ml to 0.005 g/100 ml; 0.015 g/100 ml to 0.05 g/100 ml; 0.02 g/100 ml to 0.05 g/100 ml; 0.025 g/100 ml to 0.05 g/100 ml; 0.03 g/100 ml to 0.05 g/100 ml; 0.035 g/100 ml to 0.05 g/100 ml; 0.04 g/100 ml to 0.05 g/100 ml; 0.005 g/100 ml to 0.04 g/100 ml; 0.01 g/100 ml to 0.04 g/100 ml; 0.015 g/100 ml to 0.04/100 ml; 0.020 g/100 ml to 0.04 g/100 ml; 0.025/100 ml to 0.04 g/100 ml; 0.030 g/100 ml to 0.04/100 ml; 0.005 g/100 ml to 0.035 g/100 ml; 0.01 g/100 ml to 0.035 g/100 ml; 0.015 g/100 ml to 0.035 g/100 ml; 0.020 g/100 ml to 0.035 g/100 ml; 0.025 g/100 ml to 0.035 g/100 ml; 0.005 g/100 ml to 0.05 g/100 ml; 0.005 g/100 ml to 0.045 g/100 ml; 0.005 g/100 ml to 0.035 g/100 ml; 0.005 g/100 ml to 0.03 g/100 ml; 0.005 g/100 ml to 0.025 g/100 ml; 0.005 g/100 ml to 0.02 g/100 ml; 0.005 g/100 ml to 0.015 g/100 ml; 0.01 g/100 ml to 0.05 g/100 ml; 0.01 g/100 ml to 0.04 g/100 ml; 0.01 g/100 ml to 0.03/100 ml; 0.01 g/100 ml to 0.025 g/100 ml; 0.01/100 ml to 0.02 g/100 ml; 0.01 g/100 ml to 0.015/100 ml; 0.015 g/100 ml to 0.035 g/100 ml; 0.015 g/100 ml to 0.03 g/100 ml; or 0.015 g/100 ml to 0.025 g/100 ml.

In one embodiment, the alcoholic beverage includes sodium benzoate at a content of 0.005 g/100 ml or more; 0.01 g/100 ml or more; 0.015 g/100 ml or more; 0.02 g/100 ml or more; 0.025 g/100 ml or more; 0.03 g/100 ml or more; 0.035 g/100 ml or more; 0.04 g/100 ml or more; or 0.05 g/100 ml or more. With or without the lower limit specified above, the alcoholic beverage includes sodium benzoate at a content of 0.05 g/100 ml or lower; 0.045 g/100 ml or lower; 0.03 g/100 ml or lower; 0.025 g/100 ml or lower; 0.02 g/100 ml or lower; 0.015 g/100 ml or lower; or 0.01 g/100 ml or lower.

In one embodiment, the alcoholic beverage includes potassium sorbate at a content of 0.005 g/100 ml to 0.05 g/100 ml. In another embodiment, the alcoholic beverage includes potassium sorbate at a content of 0.005 g/100 ml to 0.01 g/100 ml; 0.01 g/100 ml to 0.02 g/100 ml; 0.02 g/100 ml to 0.03 g/100 ml; 0.03 g/100 ml to 0.04 g/100 ml; 0.04 g/100 ml to 0.05 g/100 ml; 0.05 g/100 ml to 0.06 g/100 ml; 0.06 g/100 ml to 0.07 g/100 ml; 0.07 g/100 ml to 0.08 g/100 ml; 0.08 g/100 ml to 0.09 g/100 ml; 0.09 g/100 ml to 0.1 g/100 ml.

In yet another embodiment, the alcoholic beverage includes potassium sorbate at a content of 0.005 g/100 ml to 0.1 g/100 ml; 0.005 g/100 ml to 0.08 g/100 ml; 0.005 g/100 ml to 0.05 g/100 ml; 0.01 g/100 ml to 0.005 g/100 ml; 0.015 g/100 ml to 0.05 g/100 ml; 0.02 g/100 ml to 0.05 g/100 ml; 0.025 g/100 ml to 0.05 g/100 ml; 0.03 g/100 ml to 0.05 g/100 ml; 0.035 g/100 ml to 0.05 g/100 ml; 0.04 g/100 ml to 0.05 g/100 ml; 0.005 g/100 ml to 0.04 g/100 ml; 0.01 g/100 ml to 0.04 g/100 ml; 0.015 g/100 ml to 0.04/100 ml; 0.020 g/100 ml to 0.04 g/100 ml; 0.025/100 ml to 0.04 g/100 ml; 0.030 g/100 ml to 0.04/100 ml; 0.005 g/100 ml to 0.035 g/100 ml; 0.01 g/100 ml to 0.035 g/100 ml; 0.015 g/100 ml to 0.035 g/100 ml; 0.020 g/100 ml to 0.035 g/100 ml; 0.025 g/100 ml to 0.035 g/100 ml; 0.005 g/100 ml to 0.05 g/100 ml; 0.005 g/100 ml to 0.045 g/100 ml; 0.005 g/100 ml to 0.035 g/100 ml; 0.005 g/100 ml to 0.03 g/100 ml; 0.005 g/100 ml to 0.025 g/100 ml; 0.005 g/100 ml to 0.02 g/100 ml; 0.005 g/100 ml to 0.015 g/100 ml; 0.01 g/100 ml to 0.05 g/100 ml; 0.01 g/100 ml to 0.04 g/100 ml; 0.01 g/100 ml to 0.03/100 ml; 0.01 g/100 ml to 0.025 g/100 ml; 0.01/100 ml to 0.02 g/100 ml; 0.01 g/100 ml to 0.015/100 ml; 0.015 g/100 ml to 0.035 g/100 ml; 0.015 g/100 ml to 0.03 g/100 ml; or 0.015 g/100 ml to 0.025 g/100 ml.

In one embodiment, the alcoholic beverage includes potassium sorbate at a content of 0.005 g/100 ml or more; 0.01 g/100 ml or more; 0.015 g/100 ml or more; 0.02 g/100 ml or more; 0.025 g/100 ml or more; 0.03 g/100 ml or more; 0.035 g/100 ml or more; 0.04 g/100 ml or more; or 0.05 g/100 ml or more. With or without the lower limit specified above, the alcoholic beverage includes potassium sorbate at a content of 0.05 g/100 ml or lower; 0.045 g/100 ml or lower; 0.03 g/100 ml or lower; 0.025 g/100 ml or lower; 0.02 g/100 ml or lower; 0.015 g/100 ml or lower; or 0.01 g/100 ml or lower.

The alcoholic beverage can include both of sodium benzoate and potassium sorbate. In one embodiment, the alcoholic beverage includes sodium benzoate and potassium sorbate at a content of 0.01 g/100 ml to 0.1 g/100 ml. In one embodiment, the alcoholic beverage includes a total of the sodium benzoate and potassium sorbate at a content of 0.01 g/100 ml to 0.02 g/100 ml; 0.02 g/100 ml to 0.03 g/100 ml; 0.03 g/100 ml to 0.04 g/100 ml; 0.04 g/100 ml to 0.05 g/100 ml; 0.05 g/100 ml to 0.06 g/100 ml; 0.06 g/100 ml to 0.07 g/100 ml; 0.07 g/100 ml to 0.08 g/100 ml; 0.08 g/100 ml to 0.09 g/100 ml; 0.09 g/100 ml to 0.1 g/100 ml.

In yet another embodiment, the alcoholic beverage includes a combination of sodium benzoate and potassium sorbate at a content of 0.01 g/100 ml to 0.1 g/100 ml; 0.02 g/100 ml to 0.1 g/100 ml; 0.03 g/100 ml to 0.1 g/100 ml; 0.04 g/100 ml to 0.1 g/100 ml; 0.05 g/100 ml to 0.1 g/100 ml; 0.06 g/100 ml to 0.1 g/100 ml; 0.07 g/100 ml to 0.1 g/100 ml; 0.08 g/100 ml to 0.1 g/100 ml; 0.01 g/100 ml to 0.08 g/100 ml; 0.02 g/100 ml to 0.08 g/100 ml; 0.03 g/100 ml to 0.08/100 ml; 0.04 g/100 ml to 0.08 g/100 ml; 0.05/100 ml to 0.08 g/100 ml; 0.06 g/100 ml to 0.08/100 ml; 0.01 g/100 ml to 0.07 g/100 ml; 0.02 g/100 ml to 0.07 g/100 ml; 0.03 g/100 ml to 0.07 g/100 ml; 0.04 g/100 ml to 0.07 g/100 ml; 0.05 g/100 ml to 0.07 g/100 ml; 0.01 g/100 ml to 0.1 g/100 ml; 0.01 g/100 ml to 0.09 g/100 ml; 0.01 g/100 ml to 0.08 g/100 ml; 0.01 g/100 ml to 0.07 g/100 ml; 0.01 g/100 ml to 0.06 g/100 ml; 0.01 g/100 ml to 0.05 g/100 ml; 0.01 g/100 ml to 0.04 g/100 ml; 0.01 g/100 ml to 0.03 g/100 ml; 0.02 g/100 ml to 0.1 g/100 ml; 0.02 g/100 ml to 0.08 g/100 ml; 0.02 g/100 ml to 0.06/100 ml; 0.02 g/100 ml to 0.05 g/100 ml; 0.02/100 ml to 0.04 g/100 ml; 0.02 g/100 ml to 0.03/100 ml; 0.03 g/100 ml to 0.07 g/100 ml; 0.03 g/100 ml to 0.06 g/100 ml; or 0.03 g/100 ml to 0.05 g/100 ml.

In yet another embodiment, the alcoholic beverage includes a combination of sodium benzoate and potassium sorbate at a content of 0.01 g/100 ml or more; 0.02 g/100 ml or more; 0.03 g/100 ml or more; 0.04 g/100 ml or more; 0.05 g/100 ml or more; 0.06 g/100 ml or more; 0.07 g/100 ml or more; 0.08 g/100 ml or more; or 0.09 g/100 ml or more. With or without the lower limit specified above, the alcoholic beverage includes a combination of sodium benzoate and potassium sorbate at a content of 0.1 g/100 ml or lower; 0.09 g/100 ml or lower; 0.08 g/100 ml or lower; 0.07 g/100 ml or lower; 0.06 g/100 ml or lower; 0.05 g/100 ml or lower; 0.04 g/100 ml or lower; 0.03 g/100 ml or lower; or 0.02 g/100 ml or lower.

1-4. Lemon Juice

The alcoholic beverage can include a lemon juice.

When a lemon juice is contained in the alcoholic beverage, the lemon juice used can be of either a straight juice that is obtained by crushing and pressing fresh lemon, or a concentrated juice that is obtained by concentrating it. In one embodiment, the lemon juice used ca be transparent. However, the term “straight juice basis” means that when a concentrated lemon juice is used, the amount of a concentrated lemon juice is converted into a content of the lemon juice in terms of a straight juice.

In the specification of the present application, the content of the lemon juice is defined as a weight % in 100 mL of an alcoholic beverage (i.e., w/v %). Therefore, the content of the lemon juice (i.e., a lemon juice percentage (w/v %)) is not affected by the alcohol content in the alcoholic beverage.

In the specification of the present invention, the content of the lemon juice (i.e., a lemon juice percentage (w/v %)) is calculated by the formula below:

Lemon juice percentage (w/v %)=[weight of the lemon juice added (g)]×[concentration ratio thereof]/100 (mL)×100

In the formula above, the term “concentration ratio” as used herein refers to a relative concentration ratio of a lemon juice, assuming that a lemon juice obtained by squeezing fresh lemon (i.e., straight lemon juice) is 100%.

In the formula above, the concentration ratio is in accordance with the JAS Standard (Japan Agricultural Standards for Fruit Drinks). The JAS Standards defines a reference value of acidity for each fruit. According to the JAS Standards, the reference value of the acidity of a straight lemon juice is 4.5%.

An example of the method to calculate a content of a lemon juice in an alcoholic beverage is shown below:

First, a concentration ratio of the lemon juice to be contained in the alcoholic beverage is obtained. To do so, an acidity of a sample lemon juice is measured. An acidity (in terms of citric acid) of a sample lemon juice can be measured, for example, by means of a neutralization titration method by using an automatic potentiometric titrator (e.g. AT-500N manufactured by KYOTO ELECTRONICS MANUFACTURING CO., LTD.). For example, 10 ml of a beverage sample is added with distilled water to make a total amount of 50 ml, into which a sodium hydroxide solution (0.1 N, reagent for volumetric analysis) is dropped from a burette while stirring to adjust the pH at 8.0. Subsequently, the acidity in terms of citric acid can be calculated in accordance with the following formula:

“total beverage acidity (w/v %)”=titer (ml)×F×A×(100/amount of sample (ml))

In the formula above, F is about 1.00 (factor of 0.1 N sodium hydroxide solution), and A is 0.0064 (the number of grams of citric acid equivalent to 1 ml of sodium hydroxide solution).

The amount of an acidic flavor substance blended in the carbonated beverage can be determined by a method such as a HPLC method. When the amount of citric acid added is known and the other acidic flavor substances are not added, the acidity can be calculated from the amount of the citric acid added.

Then, the acidity thus obtained is divided by the reference value of the acidity of a fresh lemon juice (i.e., 4.5%), a concentration ratio of the sample lemon juice can be obtained.

For example, when a concentrated lemon juice has an acidity value of 31.5%, its concentrated ratio is 7 times (=31.5/4.5).

If 1 g of such a concentrated lemon juice is contained in 100 ml of an alcoholic beverage, the content of the lemon juice (w/v %) is calculated as 7 w/v % (=1 g×7%/100 ml) in accordance with the formula defined above.

In the present application, a content of the lemon juice in terms of a straight juice basis is 0.1 w/v % to 20 w/v %. In the specification of the present application, the phrase “in terms of a straight juice basis” means that the content of the lemon juice included in the alcoholic beverage is defined based on the content of a straight juice. For example, if a concentrated lemon juice is used, the content of the lemon juice should be converted into a condition when the concentrated lemon juice is diluted into a straight juice.

When the lemon juice employed is a concentrated lemon juice, the content of the lemon juice in terms of straight juice basis can be obtained by the formula below:

[Content of lemon juice in terms of a straight juice basis]=[weight of concentrated lemon juice (g) employed]×[concentrate ratio]

In one embodiment, a content of the lemon juice in terms of a straight juice basis can be 0.1 w/v % to 0.2 w/v %; 0.2 w/v % to 0.3 w/v %; 0.3 w/v % to 0.4 w/v %; 0.4 w/v % to 0.5 w/v %; 0.5 w/v % to 0.6 w/v %; 0.6 w/v % to 0.7 w/v %; 0.7 w/v % to 0.8 w/v %; 0.8 w/v % to 0.9 w/v %; 0.9 w/v % to 1.0 w/v %; 1.0 w/v % to 2.0 w/v %; 2.0 w/v % to 3.0 w/v %; 3.0 w/v % to 4.0 w/v %; 4.0 w/v % to 5.0 w/v %; 5.0 w/v % to 6.0 w/v %; 6.0 w/v % to 7.0 w/v %; 7.0 w/v % to 8.0 w/v %; 8.0 w/v % to 9.0 w/v %; 9.0 w/v % to 10 w/v %; 10 w/v % to 11 w/v %; 11 w/v % to 12 w/v %; 12 w/v % to 13 w/v %; 13 w/v % to 14 w/v %; 14 w/v % to 15 w/v %; 15 w/v % to 16 w/v %; 16 w/v % to 17 w/v % 17 w/v % to 18 w/v %; 18 w/v % to 19 w/v % and/or 19 w/v % to 20 w/v %.

In yet another embodiment, a content of the lemon juice in terms of a straight juice basis can be 0.1 w/v % to 20 w/v %; 0.2 w/v % to 20 w/v %; 0.3 w/v % to 20 w/v %; 0.4 w/v % to 20 w/v %; 0.5 w/v % to 20 w/v %; 0.6 w/v % to 20 w/v %; 0.7 w/v % to 20 w/v %; 0.8 w/v % to 20 w/v %; 0.9 w/v % to 20 w/v %; 1.0 w/v % to 20 w/v %; 1.1 w/v % to 20 w/v %; 1.2 w/v % to 20 w/v %; 1.3 w/v % to 20 w/v %; 1.5 w/v % to 20 w/v %; 2.5 w/v % to 20 w/v %; 3.5 w/v % to 20 w/v %; 4.5 w/v % to 20 w/v %; 5.5 w/v % to 20 w/v %; 6.5 w/v % to 20 w/v %; 7.5 w/v % to 20 w/v %; 8.5 w/v % to 20 w/v %; 9.5 w/v % to 20 w/v %; 0.1 w/v % to 18.5 w/v %; 0.2 w/v % to 18.5 w/v %; 0.3 w/v % to 18.5 w/v %; 0.4 w/v % to 18.5 w/v %; 0.1 w/v % to 17.5 w/v %; 0.2 w/v % to 17.5 w/v %; 0.3 w/v % to 17.5 w/v % 0.4 w/v % to 17.5 w/v %; 0.1 w/v % to 16.5 w/v %; 0.2 w/v % to 17.5 w/v %; 0.3 w/v % to 17.5 w/v % 0.4 w/v % to 16.5 w/v %; 0.1 w/v % to 15.5 w/v %; 0.2 w/v % to 15.5 w/v %; 0.3 w/v % to 15.5 w/v % 0.4 w/v % to 15.5 w/v %; 0.1 w/v % to 14.5 w/v %; 0.2 w/v % to 14.5 w/v %; 0.3 w/v % to 14.5 w/v % 0.4 w/v % to 14.5 w/v %; 0.1 w/v % to 13.5 w/v %; 0.2 w/v % to 13.5 w/v %; 0.3 w/v % to 13.5 w/v % 0.4 w/v % to 13.5 w/v %; 0.1 w/v % to 12.5 w/v %; 0.2 w/v % to 12.5 w/v %; 0.3 w/v % to 12.5 w/v % 0.4 w/v % to 12.5 w/v %; 0.1 w/v % to 11.5 w/v %; 0.2 w/v % to 11.5 w/v %; 0.3 w/v % to 11.5 w/v %; 0.4 w/v % to 11.5 w/v %; 0.1 w/v % to 10 w/v %; 0.2 w/v % to 10 w/v %; 0.3 w/v % to 10 w/v %; 0.4 w/v % to 10 w/v %; 0.1 w/v % to 8.0 w/v %; 0.2 w/v % to 8.0 w/v %; 0.3 w/v % to 8.0 w/v %; 0.4 w/v % to 8.0 w/v %; 0.1 w/v % to 6.0 w/v %; 0.2 w/v % to 6.0 w/v %; 0.3 w/v % to 6.0 w/v %; 0.4 w/v % to 6.0 w/v %; 0.1 w/v % to 5.0 w/v %; 0.2 w/v % to 5.0 w/v %; 0.3 w/v % to 5.0 w/v %; 0.4 w/v % to 5.0 w/v %; 0.1 w/v % to 3.0 w/v %; 0.2 w/v % to 3.0 w/v %; 0.3 w/v % to 3.0 w/v %; 0.4 w/v % to 3.0 w/v %; 0.1 w/v % to 2.0 w/v %; 0.2 w/v % to 2.0 w/v %; 0.3 w/v % to 2.0 w/v %; 0.4 w/v % to 2.0 w/v %; 0.1 w/v % to 1.0 w/v %; 0.2 w/v % to 1.0 w/v %; 0.3 w/v % to 1.0 w/v % or 0.4 w/v % to 1.0 w/v %.

In yet another embodiment, a content of the lemon juice in terms of a straight juice basis can be 0.1 w/v % or more; 1.7 w/v % or more; 2.7 w/v % or more; 3.7 w/v % or more; 4.7 w/v % or more; or 5.7 w/v % or more. With or without the lower limit above, a content of the lemon juice in terms of a straight juice basis can be 19.2 w/v % or less; 18.2 w/v % or less; 17.2 w/v % or less; 16.2 w/v % or less; 15.2 w/v % or less; or 14.2 w/v % or less.

1-5. Sugar

The alcoholic beverage can include sugar such as sucrose. In one embodiment, the alcoholic beverage includes sugar at 0.1 to 3.0 g with respect of 100 ml of the alcoholic beverage. In another embodiment, the alcoholic beverage includes sugar at 0.1 g/100 ml to 0.5 g/100 ml; 0.5 g/100 ml to 1.0 g/100 ml; 1.0 g/100 ml to 1.5 g/100 ml; 1.5 g/100 ml to 2.0 g/100 ml; 2.0 g/100 ml to 2.5 g/100 ml; and/or 2.5 g/100 ml to 3.0 g/100 ml.

In yet another embodiment, the alcoholic beverage includes sugar at 0.1 g/100 ml to 2.7 g/100 ml; 0.1 g/100 ml to 2.5 g/100 ml; 0.1 g/100 ml to 2.0 g/100 ml; 0.1 g/100 ml to 1.5 g/100 ml; 0.1 g/100 ml to 0.9 g/100 ml; 0.1 g/100 ml to 0.5 g/100 ml; 0.1 g/100 ml to 0.3 g/100 ml; 0.2 g/100 ml to 3.0 g/100 ml; 0.3 g/100 ml to 3.0 g/100 ml; 0.4 g/100 ml to 3.0 g/100 ml; 0.5 g/100 ml to 3.0 g/100 ml; 0.6 g/100 ml to 3.0 g/100 ml; 0.7 g/100 ml to 3.0 g/100 ml; or 0.3 g/100 ml to 1.0 g/100 ml.

In yet another embodiment, the alcoholic beverage includes sugar at 0.1 g/100 ml or more; 0.5 g/100 ml or more; 0.7 g/100 ml or more 1.0 g/100 ml or more; 1.5 g/100 ml or more; 2.0 g/100 ml or more; or 2.7 g/100 ml or more. With or without the lower limit above, the alcoholic beverage includes sugar at 3.0 g/100 ml or less; 2.5 g/100 ml or less; 2.3 g/100 ml or less; 2.0 g/100 ml or less; 1.7 g/100 ml or less; 1.5 g/100 ml or less; 1.3 g/100 ml or less; or 1.0 g/100 ml or less.

1-6. Citric Acid

The alcoholic beverage can include citric acid. In one embodiment, the alcoholic beverage includes citric acid at 0.1 g/100 ml to 3.0 g/100 ml. In another embodiment, the alcoholic beverage includes citric acid at 0.2 g/100 ml to 1.8 g/100 ml. In yet another embodiment, the alcoholic beverage includes citric acid at 0.44 g/100 ml to 0.66 g/100 ml. In another embodiment, the alcoholic beverage includes citric acid at 0.1 g/100 ml to 0.5 g/100 ml; 0.5 g/100 ml to 1.0 g/100 ml; 1.0 g/100 ml to 1.5 g/100 ml; 1.5 g/100 ml to 2.0 g/100 ml; 2.0 g/100 ml to 2.5 g/100 ml; and/or 2.5 g/100 ml to 3.0 g/100 ml.

In yet another embodiment, the alcoholic beverage includes citric acid at 0.2 g/100 ml to 1.7 g/100 ml; 0.2 g/100 ml to 1.5 g/100 ml; 0.2 g/100 ml to 1.3 g/100 ml; 0.2 g/100 ml to 1.1 g/100 ml; 0.2 g/100 ml to 1.0 g/100 ml; 0.2 g/100 ml to 0.8 g/100 ml; 0.2 g/100 ml to 0.7 g/100 ml; 0.2 g/100 ml to 0.5 g/100 ml; 0.2 g/100 ml to 1.8 g/100 ml; 0.25 g/100 ml to 1.8 g/100 ml; 0.3 g/100 ml to 1.8 g/100 ml; 0.35 g/100 ml to 1.8 g/100 ml; 0.40 g/100 ml to 1.8 g/100 ml; 0.45 g/100 ml to 1.8 g/100 ml; 0.5 g/100 ml to 1.8 g/100 ml; 0.3 g/100 ml to 0.9 g/100 ml; or 0.4 g/100 ml to 0.8 g/100 ml.

In yet another embodiment, the alcoholic beverage includes citric acid at 0.2 g/100 ml or more; 0.25 g/100 ml or more; or 0.3 g/100 ml or more; 0.35 g/100 ml or more; 0.4 g/100 ml or more; 0.44 g/100 ml or more; 0.45 g/100 ml or more; or 0.5 g/100 ml or more. With or without the lower limit above, the alcoholic beverage includes citric acid at 1.8 g/100 ml or less; 1.7 g/100 ml or less; or 1.6 g/100 ml or less; 1.5 g/100 ml or less; 1.4 g/100 ml or less; 1.3 g/100 ml or less; 1.2 g/100 ml or less; or 1.1 g/100 ml or less.

1-7. Sodium Citrate

The alcoholic beverage can include sodium citrate. In one embodiment, the alcoholic beverage can include sodium citrate at 0.01 g/100 ml to 3.0 g/100 ml. In another embodiment, the alcoholic beverage includes sodium citrate at 0.1 g/100 ml to 1.3 g/100 ml. In yet another embodiment, the alcoholic beverage includes sodium citrate at 0.11 g/100 ml to 0.44 g/100 ml. In another embodiment, the alcoholic beverage includes sodium citrate at 0.01 g/100 ml to 0.1 g/100 ml; 0.1 g/100 ml to 0.2 g/100 ml; 0.2 g/100 ml to 0.3 g/100 ml; 0.3 g/100 ml to 0.4 g/100 ml; 0.4 g/100 ml to 0.5 g/100 ml; 0.5 g/100 ml to 1.0 g/100 ml; 1.0 g/100 ml to 1.5 g/100 ml; 1.5 g/100 ml to 2.0 g/100 ml; 2.0 g/100 ml to 2.5 g/100 ml; and/or 2.5 g/100 ml to 3.0 g/100 ml.

In yet another embodiment, the alcoholic beverage includes sodium citrate at 0.01 g/100 ml to 2.8 g/100 ml; 0.01 g/100 ml to 2.6 g/100 ml; 0.01 g/100 ml to 2.4 g/100 ml; 0.01 g/100 ml to 2.2 g/100 ml; 0.01 g/100 ml to 2.0 g/100 ml; 0.01 g/100 ml to 1.8 g/100 ml; 0.01 g/100 ml to 1.6 g/100 ml; 0.01 g/100 ml to 1.4 g/100 ml; 0.01 g/100 ml to 1.2 g/100 ml; 0.01 g/100 ml to 1.0 g/100 ml; 0.01 g/100 ml to 0.8 g/100 ml; 0.01 g/100 ml to 0.6 g/100 ml; 0.01 g/100 ml to 0.4 g/100 ml; 0.01 g/100 ml to 0.22 g/100 ml; 0.02 g/100 ml to 3.0 g/100 ml; 0.05 g/100 ml to 3.0 g/100 ml; 0.08 g/100 ml to 3.0 g/100 ml; 0.1 g/100 ml to 3.0 g/100 ml; 0.15 g/100 ml to 3.0 g/100 ml; 0.18 g/100 ml to 3.0 g/100 ml; 0.2 g/100 ml to 3.0 g/100 ml; 0.22 g/100 ml to 3.0 g/100 ml; 0.3 g/100 ml to 3.0 g/100 ml; 0.4 g/100 ml to 3.0 g/100 ml; 0.5 g/100 ml to 3.0 g/100 ml; 0.6 g/100 ml to 3.0 g/100 ml; 0.7 g/100 ml to 3.0 g/100 ml; 0.1 g/100 ml to 0.4 g/100 ml; or 0.08 g/100 ml to 0.55 g/100 ml;

In yet another embodiment, the alcoholic beverage includes sodium citrate at 0.01 g/100 ml or more; 0.08 g/100 ml or more; or 0.1 g/100 ml or more; 0.15 g/100 ml or more; 0.18 g/100 ml or more; 0.2 g/100 ml or more; 0.22 g/100 ml or more; or 0.5 g/100 ml or more. With or without the lower limit above, the alcoholic beverage includes sodium citrate at 3.0 g/100 ml or less; 2.7 g/100 ml or less; or 2.5 g/100 ml or less; 2.1 g/100 ml or less; 1.8 g/100 ml or less; 1.5 g/100 ml or less; 1.3 g/100 ml or less; 1.1 g/100 ml or less; 0.8 g/100 ml or less; 0.6 g/100 ml or less; or 0.5 g/100 ml or less.

1-8. Na Sources

The alcoholic beverage of the present application includes sodium, which can originate from sodium benzoate and others. The examples of the other Na source can be e.g., sodium chloride, sodium hydroxide, sodium malate, sodium sulfate, sodium citrate, sodium phosphate, sodium carbonate, sodium disulfide, sodium bicarbonate, sodium alginate, sodium alginate, sodium glucoheptanoate, gluconate. sodium glutamate, sodium tartrate, sodium aspartate, sodium lactate, sodium caseinate, sodium ascorbate and mixtures thereof.

1-9. Na Content

In one embodiment, the alcoholic beverage has a Na content of 10.0 to 30.0 mg per 12 oz (355 ml). In another embodiment, the alcoholic beverage has a Na content of 11.5 to 28.9 mg per 12 oz (355 ml). In yet another embodiment, the alcoholic beverage has a Na content (mg per 12 oz) of 10.0 to 10.5; 10.5 to 11.0; 11.0 to 11.5; 11.5 to 12.0; 12.0 to 12.5; 12.5 to 13.0; 13.0 to 13.5; 13.5 to 14.0; 14.0 to 14.5; 14.5 to 15.0; 15.0 to 15.5; 15.5 to 16.0; 16.0 to 16.5; 16.5 to 17.0; 17.0 to 17.5; 17.5 to 18.0; 18.0 to 18.5; 18.5 to 19.0; 19.0 to 19.5; 19.5 to 20.0; 20.0 to 20.5; 20.5 to 21.0; 21.0 to 21.5; 21.5 to 22.0; 22.0 to 22.5; 22.5 to 23.0; 23.0 to 23.5; 23.5 to 24.0; 24.0 to 24.5; 24.5 to 25.0; 25.0 to 25.5; 25.5 to 26.0; 26.0 to 26.5; 26.5 to 27.0; 27.0 to 27.5; 27.5 to 28.0; 28.0 to 28.5; 28.5 to 28.9; 28.9 to 29.0; 29.0 to 29.5; and 29.5 to 30.0. Note that each number in this paragraph has a unit of mg per 12 oz.

In yet another embodiment, the alcoholic beverage has a Na content (mg per 12 oz) of 10.0 to 28.0; 10.0 to 27.0; 10.0 to 26.0; 10.0 to 25.0; 10.0 to 24.0; 10.0 to 23.0; 10.0 to 22.0; 10.0 to 21.0; 10.0 to 20.0; 10.0 to 19.0; 10.0 to 18.0; 10.0 to 17.0; 10.0 to 16.0; 10.0 to 15.0; 10.0 to 14.0; 10.0 to 13.0; 10.0 to 12.0; 10.0 to 30.0; 10.2 to 30.0; 10.5 to 30.0; 10.7 to 30.0; 11.0 to 30.0; 11.2 to 11.5; 11.7 to 30.0; 11.9 to 30.0; 12.3 to 30.0; 12.5 to 30.0; 13.0 to 30.0; 13.5 to 30.0; 14.0 to 30.0; 14.5 to 30.0; 15.0 to 30.0; 17.0 to 30.0; 20.0 to 30.0; 22.0 to 30.0; 25.0 to 30.0; 28.0 to 30.0; or 28.9 to 30.0. Note that each number in this paragraph has a unit of mg per 12 oz.

In yet another embodiment, the alcoholic beverage has a Na content (mg per 12 oz) of 10.0 or more; 10.5 or more; 11.0 or more; 11.5 or more; 11.9 or more; 12.5 or more, 13.5 or more, 14.5 or more; 15.5 or more; 16.5 or more; 17.5 or more; 18.5 or more. With or without the lower limit above, the alcoholic beverage has a Na content (mg per 12 oz) of 30.0 or less; 29.5 or less; 29.0 or less; 28.9 or less; 28.0 or less; 25.0 or less, 20.0 or less, 18.0 or less; 15.5 or less; 14.5 or less; 13.5 or less; or 12.5 or less. Note that each number in this paragraph has a unit of mg per 12 oz.

1-10. pH

In one embodiment, the alcoholic beverage has a pH value of 2.40 to 4.00. In another embodiment, the alcohol beverage has a pH value of 2.46 to 3.67. In yet another embodiment, the alcohol beverage has a pH value of 2.40 to 2.50; 2.50 to 2.60; 2.60 to 2.70; 2.70 to 2.80; 2.80 to 2.90; 2.90 to 3.00; 3.00 to 3.10; 3.10 to 3.20; 3.20 to 3.30; 3.30 to 3.40; 3.40 to 3.50; 3.50 to 3.60; 3.60 to 3.70; 3.70 to 3.80; 3.80 to 3.90; and/or 3.90 to 4.00.

In yet another embodiment, the alcohol beverage has a pH value of 2.40 to 3.90; 2.40 to 3.80; 2.40 to 3.70; 2.40 to 3.67; 2.40 to 3.60; 2.40 to 3.50; 2.40 to 3.40; 2.40 to 3.39; 2.40 to 3.30; 2.40 to 3.20; 2.40 to 3.00; 2.40 to 2.90; 2.40 to 2.80; 2.40 to 4.00; 2.50 to 4.00; 2.60 to 4.00; 2.70 to 4.00; 2.80 to 4.00; 2.90 to 4.00; 3.00 to 4.00; 3.10 to 4.00; 3.20 to 4.00; 3.30 to 4.00; 3.39 to 4.00; or 3.40 to 4.00.

In yet another embodiment, the alcohol beverage has a pH value of 2.40 or more; 2.50 or more; 2.60 or more; 2.70 or more; 2.80 or more; 2.90 or more; 3.00 or more; 3.10 or more; 3.20 or more; 3.30 or more; 3.37 or more; 3.39 or more; 3.40 or more; 3.50 or more. With or without the lower limit identified above, the alcohol beverage has a pH value of 4.00 or less; 3.90 or less; 3.85 or less; 3.80 or less; 3.75 or less; 3.70 or less; 3.67 or less; 3.60 or less; or 3.55 or less.

1-11. Carbonated Beverage

The alcoholic beverage of the present application can include carbonated gas. The alcoholic beverage of the present application can be a carbonated alcoholic beverage. In one embodiment, the gas pressure of the carbonated alcoholic beverage can be 0.5 to 5.0 kgf/cm². In another embodiment, the gas pressure of the carbonated alcoholic beverage can be 0.5 to 0.8 kgf/cm²; 0.8 to 1.3 kgf/cm²; 1.3 to 1.6 kgf/cm²; 1.6 to 1.8 kgf/cm²; 1.8 to 2.1 kgf/cm²; 2.1 to 2.4 kgf/cm²; 2.4 to 2.7 kgf/cm²; 2.7 to 3.0 kgf/cm²; 3.0 to 3.3 kgf/cm²; 3.3 to 3.6 kgf/cm²; 3.6 to 3.9 kgf/cm²; 3.9 to 4.2 kgf/cm²; 4.2 to 4.5 kgf/cm²; 4.5 to 4.8 kgf/cm 2; and/or 4.8 to 5.0 kgf/cm 2.

In yet another embodiment, the gas pressure of the carbonated alcoholic beverage can be 0.5 to 4.8 kgf/cm²; 0.5 to 4.6 kgf/cm²; 0.5 to 4.4 kgf/cm²; 0.5 to 4.2 kgf/cm²; 0.5 to 4.0 kgf/cm²; 0.5 to 3.8 kgf/cm²; 0.5 to 3.6 kgf/cm²; 0.5 to 3.4 kgf/cm²; 0.5 to 3.2 kgf/cm²; 0.5 to 3.0 kgf/cm²; 0.5 to 2.8 kgf/cm²; 0.5 to 2.6 kgf/cm²; 0.5 to 2.4 kgf/cm²; 0.5 to 2.2 kgf/cm²; 0.5 to 2.0 kgf/cm²; 0.5 to 1.8 kgf/cm²; 0.5 to 1.6 kgf/cm²; 0.5 to 1.4 kgf/cm²; 0.5 to 1.2 kgf/cm²; 0.5 to 1.0 kgf/cm²; 0.5 to 0.8 kgf/cm²; 0.5 to 0.6 kgf/cm²; 0.6 to 5.0 kgf/cm²; 0.8 to 5.0 kgf/cm²; 1.0 to 5.0 kgf/cm²; 1.2 to 5.0 kgf/cm²; 1.4 to 5.0 kgf/cm²; 1.6 to 5.0 kgf/cm²; 1.8 to 5.0 kgf/cm²; 2.0 to 5.0 kgf/cm²; 2.2 to 5.0 kgf/cm²; 2.4 to 5.0 kgf/cm²; 2.6 to 5.0 kgf/cm²; 2.8 to 5.0 kgf/cm²; 3.0 to 5.0 kgf/cm²; 3.2 to 5.0 kgf/cm²; 3.4 to 5.0 kgf/cm²; 3.6 to 5.0 kgf/cm²; 3.8 to 5.0 kgf/cm²; 4.0 to 5.0 kgf/cm²; 4.2 to 5.0 kgf/cm²; 4.4 to 5.0 kgf/cm²; 1.0 to 4.0 kgf/cm²; 1.5 to 3.5 kgf/cm 2; or 1.8 to 3.2 kgf/cm 2.

In yet another embodiment, the gas pressure of the carbonated alcoholic beverage can be 0.5 kgf/cm 2 or more; 1.0 kgf/cm 2 or more; 1.5 kgf/cm 2 or more; 2.0 kgf/cm 2 or more; 2.5 kgf/cm 2 or more; 3.0 kgf/cm 2 or more; 3.5 kgf/cm 2 or more; 4.0 kgf/cm 2 or more; or 4.5 kgf/cm 2 or more. With or without the lower limit above, the gas pressure of the carbonated alcoholic beverage can be 5.0 kgf/cm 2 or less; 4.5 kgf/cm 2 or less; 4.0 kgf/cm 2 or less; 3.5 kgf/cm 2 or less; 3.0 kgf/cm 2 or less; 2.5 kgf/cm 2 or less; 2.0 kgf/cm 2 or less; 1.5 kgf/cm 2 or less; or 1.0 kgf/cm 2 or less.

The content of the gas in the carbonated beverage can be defined by a gas pressure. In the specification of the present application, the term “gas pressure” refers to the gas pressure of carbon dioxide gas in the carbonated beverage contained in a container, unless otherwise specified. The gas pressure can be measured as follow: a beverage having a liquid temperature of 20° C. is fixed at a gas pressure gauge, followed by opening the stopcock of the gas pressure gauge once to release the inside to the atmosphere to remove the carbon dioxide gas in the head space, and then the stopcock is closed so as to swing the gas pressure gauge to read a value when the pointer reaches a still position. In the specification of the present application, the gas pressure of carbonated beverages is measured as explained above, unless otherwise specified.

Good tastes of the alcoholic beverage of the present application can be confirmed by e.g., panelists and/or a taste sensor device.

Sourness (A-1) Evaluated by a Taste Sensor Device

In one embodiment, the alcoholic beverage has a measurement value of the Sourness (A-1) by the taste sensor device as being 0 to 40, and in particular, 14.5 to 28.2.

In another embodiment, the alcoholic beverage has a measurement value of the Sourness (A-1) by the taste sensor device as being: 0 to 5.0; 5.0 to 10.0; 10.0 to 14.5; 14.5 to 15.0; 15.0 to 15.5; 15.5 to 16.0; 16.0 to 16.5; 16.5 to 17.0; 17.0 to 17.5; 17.5 to 18.0; 18.5 to 19.0, 19.5 to 20.0; 20.0 to 20.5; 20.5 to 21.0; 21.0 to 21.5; 21.5 to 22.0; 22.0 to 22.5; 22.5 to 23.0; 23.0 to 23.5; 23.5 to 24.0; 24.0 to 24.5, 24.5 to 25.0; 25.0 to 25.5; 25.5 to 26.0; 26.0 to 26.5; 26.5 to 27.0; 27.0 to 27.5; 27.5 to 28.0; 28.0 to 28.2; 28.2 to 30.0; 30.0 to 35.0; and or 35.0 to 40.

In yet another embodiment, the alcoholic beverage has a measurement value of the Sourness (A-1) by the taste sensor device as being: 0 or more; 3.0 or more; 6.0 or more; 9.0 or more; 12.0 or more; 14.5 or more; 16.2 or more; 18.2 or more; 19.8 or more; 20.2 or more; 20.5 or more; 22.5 or more; or 26.2 or more. With or without the lower limit of the measurement value of the Sourness (A-1) by the taste sensor device, the alcoholic beverage has a measurement value of the Sourness (A-1) by the taste sensor device as being: 40.0 or lower; 36.5 or lower; 33.5 or lower; 30.3 or lower; 29.0 or lower; 28.2 or lower; 26.0 or lower; 23.0 or lower; 22.3 or lower; 21.3 or lower; 20.3 or lower; 18.4 or lower; 16.5 or lower; 15.7 or lower.

Acidic Bitterness (A-2) Evaluated by a Taste Sensor Device

In one embodiment, the alcoholic beverage has a measurement value of the Acidic bitterness (A-2) by the taste sensor device as being −10 to 6.0, and in particular, −2.9 to 5.2. In another embodiment, the alcoholic beverage when it was felt delicious has a measurement value of the Acidic bitterness (A-2) by the taste sensor device as being: −10 to −8.0; −8.0 to −6.0; −6.0 to −4.0; −4.0 to −2.9; −2.9 to −2.6; −2.6 to −2.3; −2.3 to −2.0; −2.0 to −1.7; −1.7 to −1.4; −1.4 to −1.3; −1.3 to −1.0; −1.0 to −0.7; −0.7 to −0.4; −0.4 to −0.1; −0.1 to 0.0; 0.0 to 0.3; 0.3 to 0.6; 0.6 to 0.9; 0.9 to 1.2; 1.2 to 1.5; 1.5 to 1.8; 1.8 to 2.1; 2.1 to 2.4; 2.4 to 2.7; 2.7 to 3.0; 3.0 to 3.3; 3.3 to 3.6; 3.6 to 3.9; 3.9 to 4.2; 4.2 to 4.5; 4.5 to 4.8; 4.8 to 5.1; 5.1 to 5.2 and/or 5.1 to 6.0.

In another embodiment, the alcoholic beverage has a measurement value of the Acidic bitterness (A-2) by the taste sensor device as being −9.0 to 5.0; −8.0 to 4.5; −7.0 to 4.0; −6.0 to 3.5; −5.0 to 3.0; −4.0 to 2.5; −3.0 to 2.0; −2.0 to 1.5; −1.0 to 1.0; −0.5 to 0.5; −10.0 to −0.3; −5.0 to −0.3; −3.0 to −0.3; −0.3 to 6.0; −0.3 to 4.0; −0.3 to 3.0; −0.3 to 2.0; or −0.3 to 1.0;

In yet another embodiment, the alcoholic beverage has a measurement value of the Acidic bitterness (A-2) by the taste sensor device as being −9.5 or more; −7.5 or more; −5.5 or more; −3.5 or more; −2.0 or more; −1.0 or more; −0.5 or more; or −0.3 or more. With or without the lower limit specified above, the alcoholic beverage has a measurement value of the Acidic bitterness (A-2) by the taste sensor device as being 6.0 or less; 5.7 or less; 4.7 or less; 3.7 or less; 2.7 or less; 2.4 or less; 1.8 or less; 1.5 or less; 1.1 or less; 0.6 or less; 0.2 or less; 0.0 or less; −0.1 or less; or −0.3 or less.

Astringency (A-3) Evaluated by a Taste Sensor Device

In one embodiment, the alcoholic beverage has a measurement value of the astringency (A-3) by the taste sensor device as being 2.0 to 7.5 or in particular, 5.5 to 6.7. In another embodiment, the alcoholic beverage when it was felt delicious has a measurement value of the astringency (A-3) by the taste sensor device as being: 2.0 to 3.0; 3.0 to 4.0; 4.0 to 5.0; 5.0 to 5.5; 5.5 to 5.6; 5.6 to 5.7; 5.7 to 5.8; 5.8 to 5.9; 5.9 to 6.0; 6.0 to 6.1; 6.1 to 6.2; 6.2 to 6.3; 6.3 to 6.4; 6.4 to 6.5; 6.5 to 6.6; 6.6 to 6.7; 6.7 to 7.0; and/or 7.0 to 7.5.

In another embodiment, the alcoholic beverage has a measurement value of the astringency (A-3) by the taste sensor device as being 2.5 to 7.0; 3.0 to 7.0; 3.5 to 7.0; 3.8 to 6.7; 4.2 to 6.5; 4.5 to 6.3; 4.8 to 6.3; 5.1 to 6.3; 5.4 to 6.2; 5.6 to 6.0; 2.5 to 5.8; 4.0 to 5.8; 5.0 to 5.8; 5.8 to 7.5; 5.8 to 7.0; 5.8 to 6.5; or 5.8 to 6.3.

In another embodiment, the alcoholic beverage has a measurement value of the astringency (A-3) by the taste sensor device as being 2.5 or more; 2.7 or more; 3.7 or more; 4.7 or more; 4.9 or more; 5.1 or more; 5.3 or more; 5.5 or more; or 5.8 or more. With or without the lower limit specified above, the alcoholic beverage has a measurement value of the astringency (A-3) by the taste sensor device as being 7.5 or less; 7.1 or less; 6.6 or less; 6.3 or less; 6.1 or less; 6.0 or less; 5.9 or less; or 5.8 or less.

Umami (A-4) Evaluated by A Taste Sensor Device

In one embodiment, the alcoholic beverage has a measurement value of the Umami (A-4) by the taste sensor device as being −16.0 to 5.0, and in particular, −6.7 to −2.0. In another embodiment, the alcoholic beverage when it was felt delicious has a measurement value of the Umami (A-4) by the taste sensor device as being: −16.0 to −13.0; −13.0 to −10.0; −10.0 to −8.0; −8.0 to −6.7; −6.7 to −6.5; −6.5 to −6.3; −6.3 to −6.1; −6.1 to −5.9; −5.9 to −5.7; −5.7 to −5.5; −5.5 to −5.3; −5.3 to −5.1; −5.1 to −4.9; −4.9 to −4.7; −4.7 to −4.5; −4.5 to −4.3; −4.3 to −4.1; −4.1 to −3.9; −3.9 to −3.7; −3.7 to −3.5; −3.5 to −3.3; −3.3 to −3.1; −3.1 to −2.9; −2.9 to −2.7; −2.7 to −2.5; −2.5 to −2.3; −2.3 to −2.1; −2.1 to −2.0, −2.0 to 0.0; 0.0 to 2.0; 2.0 to 3.0; and/or 3.0 to 5.0.

In one embodiment, the alcoholic beverage has a measurement value of the Umami (A-4) by the taste sensor device as being: −15.5 to 5.0; −14.0 to 5.0; −12.0 to 4.0; −10.0 to 3.0; −8.0 to 3.0; −6.0 to −1.0; −5.8 to 0.0; −5.5 to −0.5; −5.0 to −0.7; −5.0 to −1.2; −5.0 to −1.5; −5.0 to −2.0; −5.0 to −2.5; −5.0 to −3.0; −5.0 to −3.5; −4.5 to −3.5; −4.5 to −4.0; −4.3 to −4.0; −16.0 to −4.1; −10.0 to −4.1; −8.0 to −4.1; −6.0 to −4.1; −4.1 to 5.0; −4.1 to 3.0; −4.1 to 1.0; −4.1 to 0.0; −4.1 to −1.0; or −4.1 to −2.0.

In one embodiment, the alcoholic beverage has a measurement value of the Umami (A-4) by the taste sensor device as being: −16.0 or more; −12.5 or more; −9.0 or more; −7.5 or more; −6.8 or more; −5.0 or more; −4.5 or more; or −4.1 or more. With or without the lower limit specified above, the alcoholic beverage has a measurement value of the Umami (A-4) by the taste sensor device as being: 5.0 or less; 4.0 or less; 3.0 or less; 2.0 or less; 1.0 or less; 0.0 or less; −1.0 or less; −1.5 or less; −2.0 or less; −2.5 or less; −3.5 or less; −3.8 or less; −4.0 or less; or −4.1 or less.

Saltiness (A-5) Evaluated by a Taste Sensor Device

In one embodiment, the alcoholic beverage has a measurement value of the saltiness (A-5) by the taste sensor device as being 15.0 to 30.0, and in particular, 21.4 to 26.6. In another embodiment, the alcoholic beverage when it was felt delicious has a measurement value of the Saltiness (A-5) by the taste sensor device as being: 15.0 to 18.0; 18.0 to 21.4; 21.4 to 21.6; 21.6 to 21.8; 21.8 to 22.0; 22.0 to 22.2; 22.2 to 22.4; 22.4 to 22.6; 22.6 to 22.8; 22.8 to 23.0; 23.0 to 23.2; 23.2 to 23.4; 23.4 to 23.6; 23.6 to 23.8; 23.8 to 24.0; 24.0 to 24.2; 24.2 to 24.4; 24.4 to 24.6; 24.6 to 24.8; 24.8 to 25.0; 25.0 to 25.2; 25.2 to 25.4; 25.4 to 25.6; 25.6 to 25.8; 25.8 to 26.0; 26.0 to 26.2; 26.2 to 26.4; 26.4 to 26.6; 26.6 to 28.0; or 28.0 to 30.0.

In another embodiment, the alcoholic beverage has a measurement value of the saltiness (A-5) by the taste sensor device as being; 15.0 to 29.0; 17.0 to 28.0; 19.0 to 27.0; 21.0 to 27.0; 23.0 to 27.0; 24.0 to 27.0; 24.0 to 26.0; 24.0 to 25.5; 15.0 to 24.8; 18.0 to 24.8; 21.0 to 24.8; 23.0 to 24.8; 24.8 to 30.0; or 24.8 to 27.0.

In another embodiment, the alcoholic beverage has a measurement value of the saltiness (A-5) by the taste sensor device as being; 15.0 or more; 17.5 or more; 20.5 or more; 21.7 or more; 22.7 or more; 23.7 or more; 24.1 or more; or 24.8 or more. With or without the lower limit specified above, the alcoholic beverage has a measurement value of the saltiness (A-5) by the taste sensor device as being: 30.0 or less; 29.0 or less; 28.0 or less; 27.0 or less; 26.0 or less; 25.0 or less; or 24.8 or less.

Bitter Aftertaste (A-6) Evaluated by a Taste Sensor Device

In one embodiment, the alcoholic beverage has a measurement value of the bitter aftertaste (A-6) by the taste sensor device as being: −1.0 to 4.0, and in particular, 0.4 to 1.3. In another embodiment, the alcoholic beverage when it was felt delicious has a measurement value of the bitter aftertaste (A-6) by the taste sensor device as being: −1.0 to 0.0; 0.0 to 0.4; 0.4 to 0.5; 0.5 to 0.6; 0.6 to 0.7; 0.7 to 0.8; 0.8 to 0.9; 0.9 to 1.0; 1.0 to 1.1; 1.1 to 1.2; 1.2 to 1.3; 0.3 to 2.5; and/or 2.5 to 4.0.

In one embodiment, the alcoholic beverage has a measurement value of the bitter aftertaste (A-6) by the taste sensor device as being: −1.0 to 3.0; −1.0 to 2.0; −1.0 to 1.5;-0.0 to 1.5;-1.0 to 0.8; 0.8 to 4.0; 0.8 to 3.0; 0.8 to 2.0; 0.8 to 1.5; or 0.8 to 1.2.

In one embodiment, the alcoholic beverage has a measurement value of the bitter aftertaste (A-6) by the taste sensor device as being:-1.0 or more; −0.1 or more; 0.2 or more; 0.5 or more; 0.7 or more; or 0.8 or more. With or without the lower limit specified above, the alcoholic beverage has a measurement value of the bitter aftertaste (A-6) by the taste sensor device as being: 4.0 or less; 3.1 or less; 2.1 or less; 1.5 or less; 1.3 or less; 1.1 or less; 0.9 or less; or 0.8 or less.

Astringent Aftertaste (A-7) Evaluated by a Taste Sensor Device

In one embodiment, the alcoholic beverage when it was felt delicious has a measurement value of the astringent aftertaste (A-7) by the taste sensor device as being 0.3 to 1.3. In another embodiment, the alcoholic beverage when it was felt delicious has a measurement value of the Astringent aftertaste (A-7) by the taste sensor device as being: 0.3 to 0.4; 0.4 to 0.5; 0.5 to 0.6; 0.6 to 0.7; 0.7 to 0.8; 0.8 to 0.9; 0.9 to 1.0; 1.0 to 1.1; 1.1 to 1.2; and/or 1.2 to 1.3

In one embodiment, the alcoholic beverage has a measurement value of the astringent aftertaste (A-7) by the taste sensor device as being:-1.0 to 3.0;-1.0 to 2.0;-1.0 to 1.5;-0.0 to 1.5; −1.0 to 0.7; 0.7 to 4.0; 0.7 to 3.0; 0.7 to 2.0; 0.7 to 1.5; or 0.7 to 1.2.

In one embodiment, the alcoholic beverage has a measurement value of the astringent aftertaste (A-7) by the taste sensor device as being:-1.0 or more; −0.1 or more; 0.2 or more; 0.5 or more; 0.6 or more; or 0.7 or more. With or without the lower limit specified above, the alcoholic beverage has a measurement value of the astringent aftertaste (A-7) by the taste sensor device as being: 4.0 or less; 3.1 or less; 2.1 or less; 1.5 or less; 1.3 or less; 1.1 or less; 0.8 or less; or 0.7 or less.

Umami Aftertaste (A-8) Evaluated by a Taste Sensor Device

In one embodiment, the alcoholic beverage when it was felt delicious has a measurement value of the Umami aftertaste (A-8) by the taste sensor device as being −0.5 to 1.2. In another embodiment, the alcoholic beverage when it was felt delicious has a measurement value of the Umami aftertaste (A-8) by the taste sensor device as being:-3.0 to −2.0;-2.0 to −1.0; −1.0 to −0.5; −0.5 to −0.4; −0.4 to −0.3; −0.3 to −0.2; −0.2 to −0.1; −0.1 to 0.0; 0.0 to 0.1; 0.1 to 0.2; 0.2 to 0.3; 0.3 to 0.4; 0.4 to 0.5; 0.5 to 0.6; 0.6 to 0.7; 0.7 to 0.8; 0.8 to 0.9; 0.9 to 1.0; 1.0 to 1.1; 1.1 to 1.2; 1.2 to 2.0; 2.0 to 3.0; and/or 3.0 to 4.0.

In one embodiment, the alcoholic beverage has a measurement value of the Umami aftertaste (A-8) by the taste sensor device as being:-3.0 to 3.0;-1.0 to 3.0;-1.0 to 2.0;-1.0 to 1.5; −0.0 to 1.5;-1.0 to 0.2; 0.2 to 4.0; 0.2 to 3.0; 0.2 to 2.0; 0.2 to 1.5; 0.2 to 1.2; 0.2 to 4.0.

In one embodiment, the alcoholic beverage has a measurement value of the Umami aftertaste (A-8) by the taste sensor device as being: −3.0 to more; −2.0 or more; −1.0 or more; −0.5 or more; −0.1 or more; 0.0 or more; 0.1 or more; or 0.2 or more. With or without the lower limit specified above, the alcoholic beverage has a measurement value of the Umami aftertaste (A-8) by the taste sensor device as being: 4.0 or less; 3.1 or less; 2.1 or less; 1.5 or less; 1.3 or less; 1.1 or less; 0.5 or less; or 0.2 or less.

Sum of (A-2), (A-6) and (A-7)

The acidic bitterness (A-2), bitter aftertaste (A-6) and astringent aftertaste (A-7) could make beverage hard to drink. In one embodiment, when the sum of the acidic bitterness (A-2), bitter aftertaste (A-6) and astringent aftertaste (A-7) is 0.5 to 2.2, more particularly 1 to 1.5, the alcoholic beverage of the present application is considered to be felt delicious.

(A-1)/(A-5)

It is considered that an alcoholic beverage having an appropriate ratio of sourness (A-1) to saltiness (A-5) [i.e., (A-1)/(A-5)×100] is an important factor to make the inventive alcoholic beverage taste good. In one embodiment, when the alcoholic beverage has a ratio of sourness (A-1) to saltiness (A-5) as being 50 to 200, the alcoholic beverage of the present application is felt tasty.

In one embodiment, the alcoholic beverage has a ratio of sourness (A-1) to saltiness (A-5) [i.e., (A-1)/(A-5)×100] as being 50 to 60; 60 to 70; 70 to 80, 80 to 82; 82 to 84; 84 to 86; 86 to 88; 88 to 90; 90 to 92; 92 to 94; 94 to 96; 96 to 98; 98 to 100; 100 to 110; 110 to 120; 120 to 130; 130 to 140; 140 to 150; 150 to 160′; 160 to 170; 170 to 180; 180 to 190; and/or 190 to 200.

In another embodiment, the alcoholic beverage has a ratio of sourness (A-1) to saltiness (A-5) [i.e., (A-1)/(A-5)×100] as being 60 to 180; 60 to 150; 60 to 120; 60 to 100; 70 to 120; 70 to 100; 70 to 90; 80 to 95; 80 to 95; 80 to 91; 80 to 88; 81 to 86; or 81 to 84.

### EXAMPLES

Next, the alcoholic beverage of the present application is explained with reference to examples.

Each sample for Evaluation Tests A, B and C was prepared by using Grain Neutral Spirit (GNS), sucrose, Reb D, potassium sorbate, sodium benzoate, citric acid, sodium citrate, lemon juice and water at the contents as shown in Tables 1 to 3. In each sample, water was added to become a total volume of 100 ml. Each sample thus prepared was filled in a bottle.

The raw materials used are as follows: As an alcohol Grain Neutral Spirit (GNS): 95.5 v/v % was used. As sugar, commercially available: Solid Sucrose was used. As Reb D, a commercially available product having a purity of 90% or more was used. As potassium sorbate, a commercial product from NINGBO WANGLONG TECH CO., LTD was used. As sodium benzoate, a commercial product from Tianjin Dongda Chemical Group Co., Ltd. was used. As citric acid anhydrate, a commercial product from Tate & Lyle was used. As sodium citrate, a commercial product from Jungbunzlauer was used. As lemon juice, a commercially available concentrated juice (transparent; (Acid 31.00-33.50% as Citric) was used. As water, deionized water was used.

A pH value of each sample in Tables 1 and 2 was measured, which result is also shown therein. A Na content per 12 oz (355 ml) of the sample was calculated, which result is also shown therein.

TABLE 1

| Sample No. | 1 | 6 | 7 | 8 | 9 | 10 | 11 | 12 | 13 |
|---|---|---|---|---|---|---|---|---|---|
| GNS | 6.282 | 6.282 | 6.282 | 6.282 | 6.282 | 6.282 | 6.282 | 10.342 | 0.395 |
| 95.5% abv | | | | | | | | | |
| (ml) | | | | | | | | | |
| Sucrose (g) | 0.776 | 0.776 | 0.776 | 0.776 | 0.776 | 0.776 | 0.776 | 0.776 | 0.776 |
| Reb D (g) | 0.016 | 0.016 | 0.016 | 0.016 | 0.016 | 0.016 | 0.016 | 0.016 | 0.016 |
| Potassium | 0.02 | 0.1 | 0.001 | 0.02 | 0.02 | 0.02 | 0.02 | 0.02 | 0.02 |
| Sorbate (g) | | | | | | | | | |
| Sodium | 0.02 | 0.1 | 0.001 | 0.02 | 0.02 | 0.02 | 0.02 | 0.02 | 0.02 |
| Benzoate (g) | | | | | | | | | |
| Citric Acid | 0.66 | 0.66 | 0.66 | 1.94 | 0.441 | 0.66 | 0.66 | 0.66 | 0.66 |
| Anhydrate | | | | | | | | | |
| (g) | | | | | | | | | |
| Sodium | 0 | 0 | 0 | 0 | 0 | 0 | 0 | 0 | 0 |
| Citrate (g) | | | | | | | | | |
| Lemon Juice | 0.4 | 0.4 | 0.4 | 0.4 | 0.4 | 2 | 0.02 | 0.4 | 0.4 |
| (g)(added | | | | | | | | | |
| amount of the | | | | | | | | | |
| concentrated | | | | | | | | | |
| lemon juice) | | | | | | | | | |
| Lemon Juice | 2 | 2 | 2 | 2 | 2 | 13 | 0.1 | 2 | 2 |
| (straight | | | | | | | | | |
| juice | | | | | | | | | |
| basis)w/v % | | | | | | | | | |
| Water (ml) | QS to 100 | QS to 100 | QS to 100 | QS to 100 | QS to 100 | QS to 100 | QS to 100 | QS to 100 | QS to 100 |
| Total (ml) | 100 | 100 | 100 | 100 | 100 | 100 | 100 | 100 | 100 |
| pH value | 2.51 | 2.92 | 2.40 | 2.19 | 2.60 | 2.68 | 2.49 | 2.54 | 2.46 |
| Na content | 11.8 | 57.0 | 1.0 | 11.8 | 11.8 | 12.7 | 11.5 | 11.8 | 11.8 |
| (mg per 12 oz | | | | | | | | | |
| (355 ml)) | | | | | | | | | |

TABLE 2

| Sample No. | 14 | 15 | 16 | 17 | 18 | 19 | 20 | 21 | 22 |
|---|---|---|---|---|---|---|---|---|---|
| GNS | 6.283 | 6.283 | 6.283 | 6.283 | 6.283 | 6.283 | 6.283 | 6.283 | 6.283 |
| 95.5% abv | | | | | | | | | |
| (ml) | | | | | | | | | |
| Sucrose (g) | 0.776 | 0.776 | 0.776 | 0.776 | 0.776 | 0.776 | 0.776 | 0.776 | 0.776 |
| Reb D (g) | 0.016 | 0.016 | 0.016 | 0.016 | 0.016 | 0.016 | 0.016 | 0.016 | 0.016 |
| Potassium | 0.02 | 0.08 | 0.05 | 0.005 | 0.02 | 0.02 | 0.02 | 0.02 | 0.02 |
| Sorbate (g) | | | | | | | | | |
| Sodium | 0.02 | 0.08 | 0.05 | 0.005 | 0.02 | 0.02 | 0.02 | 0.02 | 0.02 |
| Benzoate (g) | | | | | | | | | |
| Citric Acid | 0.44 | 0.44 | 0.44 | 0.44 | 4 | 0.44 | 0 | 0.44 | 0.44 |
| Anhydrate | | | | | | | | | |
| (g) | | | | | | | | | |
| Sodium | 0.22 | 0.22 | 0.22 | 0.22 | 0 | 0.11 | 1.5 | 0.22 | 0.22 |
| Citrate (g) | | | | | | | | | |
| Lemon Juice | 0.4 | 0.4 | 0.4 | 0.4 | 0.4 | 0.4 | 0.4 | 3 | 1.2 |
| (g) (added | | | | | | | | | |
| amount of the | | | | | | | | | |
| concentrated | | | | | | | | | |
| lemon juice)) | | | | | | | | | |
| Lemon Juice | 2 | 2 | 2 | 2 | 2 | 2 | 2 | 20 | 8 |
| (straight | | | | | | | | | |
| juice basis) | | | | | | | | | |
| w/v % | | | | | | | | | |
| Water (ml) | QS to 100 | QS to 100 | QS to 100 | QS to 100 | QS to 100 | QS to 100 | QS to 100 | QS to 100 | QS to 100 |
| Total (ml) | 100 | 100 | 100 | 100 | 100 | 100 | 100 | 100 | 100 |
| pH value | 3.39 | 3.67 | 3.59 | 3.37 | 1.93 | 3.03 | 5.97 | 3.21 | 2.96 |
| Na content | 11.8 | 45.9 | 28.9 | 3.4 | 11.7 | 11.8 | 13 | 13.4 | 12.4 |
| (mg per 12 oz | | | | | | | | | |
| (355 ml)) | | | | | | | | | |

(A) Evaluation Test A: Evaluation by Tasting Sensor

By means of a taste sensor device Model TS-5000Z manufactured by Intelligent Sensor Technology Ltd., tastes of the samples were evaluated. The taste sensor device can measure specific tastes such as sour taste and bitter taste to produce an evaluation number for the taste.

Samples Nos. 1 and 6-22 were provided to evaluate the tastes by means of the taste sensor device.

The evaluation was made with respect to the categories as shown below:
(A-1) Sourness,
(A-2) Acidic bitterness,
(A-3) Astringency,
(A-4) Umami,
(A-5) Saltiness,
(A-6) Bitter aftertaste,
(A-7) Astringent aftertaste, and
(A-8) Umami aftertaste.

The taste sensor device was operated at a condition of room temperature (24.1° C.). The temperature of the samples was 23.5° C.

Each sample was measured three times, which averages are shown in Tables 3 and 4.

TABLE 3

| Sample No. | No. 1 | No. 6 | No. 7 | No. 8 | No. 9 | No. 10 | No. 11 | No. 12 | No. 13 |
|---|---|---|---|---|---|---|---|---|---|
| (A-1) Sourness | 40.4 | 31.4 | 42.1 | 45.6 | 37.4 | 35.6 | 39.5 | 39.0 | 39.0 |
| (A-2) Acidic | −5.8 | 4.1 | −9.1 | −6.8 | −5.1 | −0.2 | −5.7 | −5.7 | −5.1 |
| bitterness | | | | | | | | | |
| (A-3) | 5.3 | 7.3 | 5.1 | 5.1 | 5.3 | 5.9 | 5.2 | 5.0 | 5.6 |
| Astringency | | | | | | | | | |
| (A-4) Umami | −13.4 | −7.8 | −14.8 | −14.6 | −12.4 | −9.9 | −13.2 | −12.0 | −13.8 |
| (A-5) Saltiness | 16.5 | 21.3 | 14.9 | 18.7 | 15.7 | 21.6 | 15.3 | 17.9 | 14.4 |
| (A-6) Bitter | 0.7 | 3.0 | 0.1 | 0.5 | 0.6 | 1.8 | 0.5 | 0.6 | 0.6 |
| aftertaste | | | | | | | | | |
| (A-7) | 0.5 | 2.7 | 0.0 | 0.3 | 0.4 | 1.6 | 0.6 | 0.4 | 0.4 |
| Astringent | | | | | | | | | |
| aftertaste | | | | | | | | | |
| (A-8) Umami | −0.5 | 2.3 | −1.4 | −1.7 | −0.2 | 0.7 | −0.4 | −0.6 | −0.4 |
| aftertaste | | | | | | | | | |

TABLE 4

| Sample No. | No. 14 | No. 15 | No. 16 | No. 17 | No. 18 | No. 19 | No. 20 | No. 21 | No. 22 |
|---|---|---|---|---|---|---|---|---|---|
| (A-1) Sourness | 20.5 | 14.0 | 17.0 | 21.4 | 47.1 | 14.5 | −8.6 | 28.2 | 23.8 |
| (A-2) Acidic | −0.3 | 9.0 | 5.2 | −2.9 | −3.3 | 1.9 | −0.6 | −0.3 | −0.1 |
| bitterness | | | | | | | | | |
| (A-3) | 5.8 | 8.0 | 6.7 | 5.5 | 5.4 | 6.2 | 4.9 | 5.6 | 5.6 |
| Astringency | | | | | | | | | |
| (A-4) Umami | −4.1 | 0.1 | −2.0 | −4.9 | −13.9 | −2.0 | 10.0 | −6.7 | −5.4 |
| (A-5) Saltiness | 24.8 | 26.6 | 25.6 | 24.1 | 21.5 | 21.4 | 22.1 | 26.6 | 25.3 |
| (A-6) Bitter | 0.8 | 2.2 | 1.3 | 0.4 | 0.6 | 0.7 | 0.0 | 1.0 | 0.8 |
| aftertaste | | | | | | | | | |
| (A-7) | 0.7 | 2.0 | 1.3 | 0.3 | 0.2 | 0.4 | 0.0 | 0.4 | 0.5 |
| Astringent | | | | | | | | | |
| aftertaste | | | | | | | | | |
| (A-8) Umami | 0.2 | 2.2 | 1.2 | −0.4 | −2.3 | 0.5 | 1.5 | −0.5 | −0.1 |
| aftertaste | | | | | | | | | |
| a sum of (A-2), | 1.2 | 13.2 | 7.8 | −2.2 | −2.5 | 3.1 | −0.6 | 1.1 | 1.2 |
| (A-6) and (A-7) | | | | | | | | | |
| Ratio [(A-1)/ | 83 | 53 | 66 | 89 | 219 | 68 | −39 | 106 | 94 |
| (A-5) × 100] | | | | | | | | | |

Evaluation Test B: Evaluation by Panelists

With respect to Samples Nos. 14-22, a tasting test was carried out by five panelists who had had a training and experience of tasting. The panelists were given no information about the composition and content of the samples. The tasting by the panelists was carried out at a temperature of 20° C.

The evaluation was made with respect to the categories as shown below:

(B-1) Bitter Taste
1: Feeling that it is inappropriate for beverage.
2: Feeling that it is slightly inappropriate for beverage.
3: Feeling that it is appropriate for beverage.
4: Feeling that it is more appropriate for beverage.
5: Feeling that it is very appropriate for beverage.

(B-2) Sour Taste
1: Feeling that it is inappropriate for beverage.
2: Feeling that it is slightly inappropriate for beverage.
3: Feeling that it is appropriate for beverage.
4: Feeling that it is more appropriate for beverage.
5: Feeling that it is very appropriate for beverage.

(B-3) Astringent Taste
1: Feeling that it is inappropriate for beverage.
2: Feeling that it is slightly inappropriate for beverage.
3: Feeling that it is appropriate for beverage.
4: Feeling that it is more appropriate for beverage.
5: Feeling that it is very appropriate for beverage.

(B-4) Umami
1: Feeling that it is inappropriate for beverage.
2: Feeling that it is slightly inappropriate for beverage.
3: Feeling that it is appropriate for beverage.
4: Feeling that it is more appropriate for beverage.
5: Feeling that it is very appropriate for beverage.

(B-5) Easy to Drink
1: Feeling that it is inappropriate for beverage.
2: Feeling that it is slightly inappropriate for beverage.
3: Feeling that it is appropriate for beverage.
4: Feeling that it is more appropriate for beverage.
5: Feeling that it is very appropriate for beverage.

The total points produced by the panelists in each category were averaged, which results are shown in Table 5.

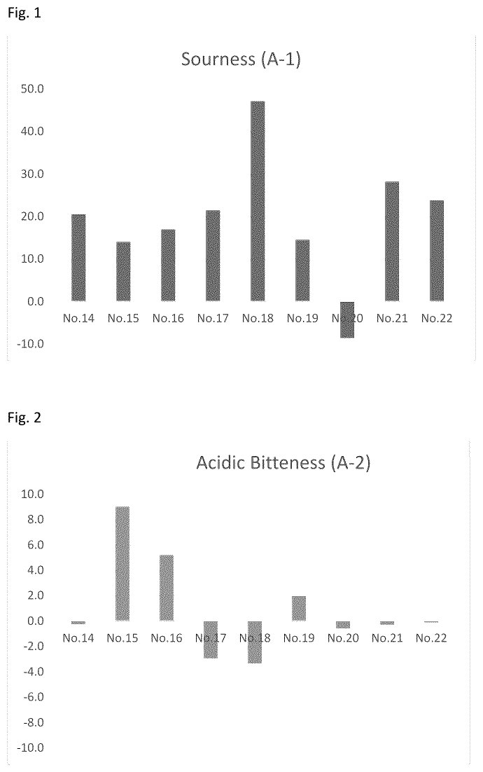

The results of the evaluations of the sourness (A-1), acidic bitterness (A-2), astringency (A-3) and Umami (A-4) are plotted in graphs shown in FIGS. 1-4, respectively.

TABLE 5

| Sample No. | 14 | 15 | 16 | 17 | 18 | 19 | 20 | 21 | 22 |
|---|---|---|---|---|---|---|---|---|---|
| (B-1) Bitter taste | 3.3 | 1.5 | 2.6 | 3.3 | 3.3 | 3.3 | 2.5 | 2.8 | 3.5 |
| (B-2) Sour taste | 2.7 | 3.0 | 3.5 | 2.5 | 2.2 | 3.0 | 1.9 | 2.4 | 3.1 |
| (B-3) Astringent taste | 3.3 | 1.5 | 2.5 | 3.3 | 2.1 | 2.7 | 1.0 | 2.5 | 2.5 |
| (B-4) Umami | 3.3 | 2.0 | 2.2 | 2.8 | 1.9 | 2.3 | 1.2 | 3.1 | 3.2 |
| (B-5) Easy to drink | 3.3 | 1.2 | 2.5 | 3.0 | 1.0 | 3.0 | 1.0 | 2.3 | 3.1 |
| Total points | 15.9 | 9.2 | 13.3 | 14.9 | 10.5 | 14.3 | 7.6 | 13.1 | 15.4 |
| Comments by panelists | | 1* | 2* | 3* | 4* | 5* | 6* | 7* | 8* |

1* Too bitter, astringent and harsh
2* Comfortable sourness, Faint astringency
3* Natural taste profile, Easy to drink, slightly thin and flat
4* Too sour to drink
5* Refreshing, not too bitter
6* Too astringent aftertaste, Not enough sourness
7* Juicy but slightly too tart
8* Thick, juicy, Natural taste profile

The samples in Table 4 were analyzed regarding acidic bitterness (A-2), bitter aftertaste (A-6) and astringent aftertaste (A-7). As shown in Samples Nos. 14, 21 and 22, it was confirmed that when a sum of the acidic bitterness (A-2), bitter aftertaste (A-6) and astringent aftertaste (A-7) was 0.5 to 2.2, more particularly 1 to 1.5, the alcoholic beverage of the present application was felt delicious.

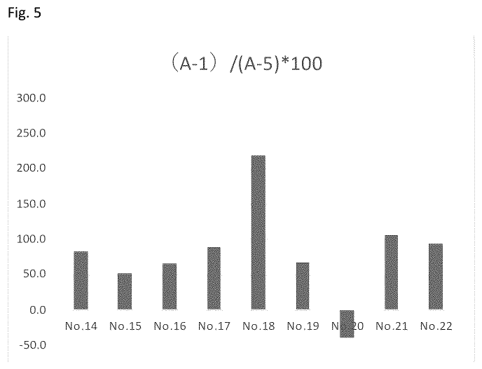

The samples in Table 4 were analyzed a ratio of sourness (A-1) to saltiness (A-5) [i.e., (A-1)/(A-5)×100]. See also FIG. 5. As shown in Samples No. 14, the alcoholic beverage has the ratio of sourness (A-1) to saltiness (A-5) as being 50 to 200.

Based on the comments by the panelists, it was found that Samples 14, 16, 17, 19, 21 and 22 are felt delicious overall as an alcoholic beverage, whereas Samples 15, 18 and 20 are not.

A comparison of the results in Table 4 with the results in Table 5 could show ranges of the measurement values by the taste sensor device when the alcoholic beverage was felt delicious.

Sourness (A-1) By Taste Sensor Device

As shown in Table 5 and FIG. 1, it was found that the alcoholic beverage when it was felt delicious by panelists in Table 5 (i.e., Samples 14, 16, 17, 19, 21 and 22) had a measurement value of the Sourness (A-1) by the taste sensor device as being 0 to 40, and in particular, 14.5 to 28.2.

Acidic Bitterness Taste (A-2) by Taste Sensor Device

As shown in Table 5 and FIG. 2, it was found that the alcoholic beverage when it was felt delicious by panelists in Table 5 (i.e., Samples 14, 16, 17, 19, 21 and 22) had a measurement value of the Acidic bitterness (A-2) by the taste sensor device as being −10 to 6.0, and in particular, −2.9 to 5.2.

Astringency (A-3) By Taste Sensor Device

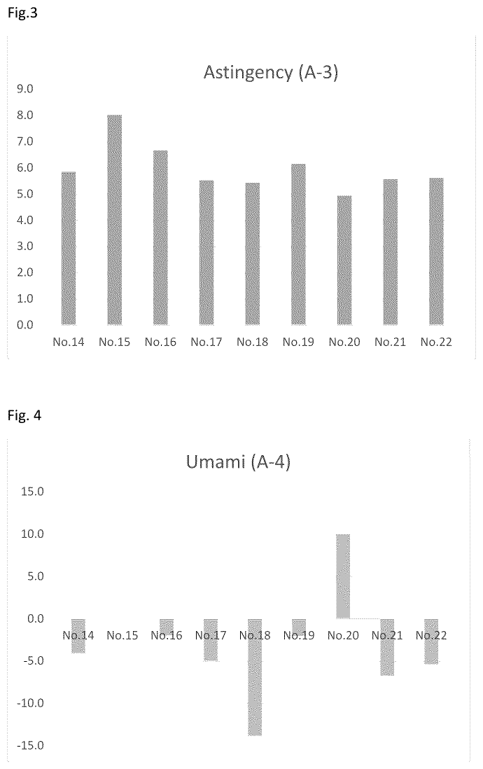

As shown in Table 5 and FIG. 3, it was found that the alcoholic beverage when it was felt delicious by panelists in Table 5 (i.e., Samples 14, 16, 17, 19, 21 and 22) had a measurement value of the astringency (A-3) by the taste sensor device as being 2.0 to 7.5 or in particular, 5.5 to 6.7.

Umami (A-4) By Taste Sensor Device

As shown in Table 5 and FIG. 3, it was found that the alcoholic beverage when it was felt delicious by panelists in Table 5 (i.e., Samples 14, 16, 17, 19, 21 and 22) had a measurement value of the Umami (A-4) by the taste sensor device as being −16.0 to 5.0, and in particular, −6.7 to −2.0.

Saltiness (A-5) By Taste Sensor Device

It was found that the alcoholic beverage when it was felt delicious by panelists in Table 5 (i.e., Samples 14, 16, 17, 19, 21 and 22) had a measurement value of the saltiness (A-5) by the taste sensor device as being 21.4 to 26.6.

Bitter Aftertaste (A-6) by Taste Sensor Device

It was found that the alcoholic beverage when it was felt delicious by panelists had a measurement value of the bitter aftertaste (A-6) by the taste sensor device as being 0.4 to 1.3.

Astringent Aftertaste (A-7) by Taste Sensor Device

It was found that the alcoholic beverage when it was felt delicious by panelists had a measurement value of the Astringent aftertaste (A-7) by the taste sensor device as being −1.0 to 4.0, and in particular, 0.3 to 1.3.

Umami Aftertaste (A-8) by Taste Sensor Device

It was found that the alcoholic beverage when it was felt delicious by panelists had a measurement value of the Umami aftertaste (A-8) by the taste sensor device as being −3.0 to 4.0, and in particular, −0.5 to 1.2.

1. An alcoholic beverage contained in a container, the alcoholic beverage comprising:
an alcohol;
one or more kinds of steviol glycosides selected from the group consisting of RebA; RebD and RebM, and
at least one of sodium benzoate and potassium sorbate in a content of 0.001 g/100 ml to 0.1 g/100 ml; wherein the alcoholic beverage has a pH of 2.0 to 3.6,
where a content of the alcohol is 2 to 8 v/v %.

2. The alcoholic beverage according to claim 1, wherein a content of the RebA; RebD and RebM, is 50 ppm to 500 ppm.

3. The alcoholic beverage according to claim 1, wherein the steviol glycoside is RebD.

4. (canceled)

5. The alcoholic beverage according to claim 1, further comprising a lemon juice.

6. The alcoholic beverage according to claim 1, wherein a lemon juice is in a content of 0.1 w/v % to 20 w/v % in terms of a straight juice basis.

7. The alcoholic beverage according to claim 1, further comprising a sugar.

8. The alcoholic beverage according to claim 1, wherein a content of the sugar is 0.3 to 3.0 g/100 ml.

9. The alcoholic beverage according to claim 1, wherein a Na content of the alcoholic beverage is 10.0 to 30.0 mg per 12 oz.

10. The alcoholic beverage according to claim 1, wherein the alcoholic beverage has a pH of 2.40 to 4.00.

11. The alcoholic beverage according to claim 1, wherein the alcoholic beverage is a carbonated beverage.
